(19) United States
(12) Patent Application Publication
(10) Pub. No.: US 2023/0376372 A1
(43) Pub. Date: Nov. 23, 2023

(54) MULTI-MODALITY ROOT CAUSE LOCALIZATION FOR CLOUD COMPUTING SYSTEMS

(71) Applicant: NEC Laboratories America, Inc., Princeton, NJ (US)

(72) Inventors: Zhengzhang Chen, Princeton Junction, NJ (US); Yuncong Chen, Plainsboro, NJ (US); LuAn Tang, Cranbury, NJ (US); Haifeng Chen, West Windsor, NJ (US)

(21) Appl. No.: 18/302,970

(22) Filed: Apr. 19, 2023

Related U.S. Application Data
(60) Provisional application No. 63/344,091, filed on May 20, 2022.
(60) Provisional application No. 63/344,085, filed on May 20, 2022.
(60) Provisional application No. 63/450,988, filed on Mar. 9, 2023.

(51) Int. Cl. G06F 11/07

(52) U.S. Cl. CPC G06F 11/079; G06F 11/0769; G06F 11/0709

(57) ABSTRACT

A method for detecting pod and node candidates from cloud computing systems representing potential root causes of failure or fault activities is presented. The method includes collecting, by a monitoring agent, multi-modality data including key performance indicator (KPI) data, metrics data, and log data, employing a feature extractor and representation learner to convert the log data to time series data, applying a metric prioritizer based on extreme value theory to prioritize metrics for root cause analysis and learn an importance of different metrics, ranking root causes of failure or fault activities by using a hierarchical graph neural network, and generating one or more root cause reports outlining the potential root causes of failure or fault activities.

### RELATED APPLICATION INFORMATION

This application claims priority to Provisional Application No. 63/344,091 filed on May 20, 2022, Provisional Application No. 63/344,085 filed on May 20, 2022, and Provisional Application No. 63/450,988 filed on Mar. 9, 2023, the contents of all of which are incorporated herein by reference in their entirety.

### BACKGROUND

### Technical Field

The present invention relates to multi-modality data and, more particularly, to root cause localization from multi-modality cloud computing system data.

### Description of the Related Art

Information Technology (IT) operation is one of the technology foundations of the increasingly digitalized world. IT is responsible for ensuring digitalized businesses and societies run reliably, efficiently, and safely. Today, most organizations are transforming from a traditional infrastructure of separate, static physical systems to a dynamic mix of cloud environments, running on virtualized or software-defined resources. Applications and systems across these environments generate a voluminous amount of data that keeps growing. In fact, it is estimated that the average enterprise IT infrastructure generates two to three times more IT operations data every year.

### SUMMARY

A method for detecting pod and node candidates from cloud computing systems representing potential root causes of failure or fault activities is presented. The method includes collecting, by a monitoring agent, multi-modality data including key performance indicator (KPI) data, metrics data, and log data, employing a feature extractor and representation learner to convert the log data to time series data, applying a metric prioritizer based on extreme value theory to prioritize metrics for root cause analysis and learn an importance of different metrics, ranking root causes of failure or fault activities by using a hierarchical graph neural network, and generating one or more root cause reports outlining the potential root causes of failure or fault activities.

A non-transitory computer-readable storage medium comprising a computer-readable program for detecting pod and node candidates from cloud computing systems representing potential root causes of failure or fault activities is presented. The computer-readable program when executed on a computer causes the computer to perform the steps of collecting, by a monitoring agent, multi-modality data including key performance indicator (KPI) data, metrics data, and log data, employing a feature extractor and representation learner to convert the log data to time series data, applying a metric prioritizer based on extreme value theory to prioritize metrics for root cause analysis and learn an importance of different metrics, ranking root causes of failure or fault activities by using a hierarchical graph neural network, and generating one or more root cause reports outlining the potential root causes of failure or fault activities.

A system for detecting pod and node candidates from cloud computing systems representing potential root causes of failure or fault activities is presented. The system includes a processor and a memory that stores a computer program, which, when executed by the processor, causes the processor to collect, by a monitoring agent, multi-modality data including key performance indicator (KPI) data, metrics data, and log data, employ a feature extractor and representation learner to convert the log data to time series data, apply a metric prioritizer based on extreme value theory to prioritize metrics for root cause analysis and learn an importance of different metrics, rank root causes of failure or fault activities by using a hierarchical graph neural network, and generate one or more root cause reports outlining the potential root causes of failure or fault activities.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram of an exemplary multi-modality root cause localization system applied to input data, in accordance with embodiments of the present invention;

FIG. 2 is a block/flow diagram of an exemplary cloud intelligence system architecture, in accordance with embodiments of the present invention;

FIG. 3 is a block/flow diagram of existing multi-modal root cause localization;

FIG. 4 is a block/flow diagram of an exemplary multi-modal root cause localization, in accordance with embodiments of the present invention;

FIG. 5 is a block/flow diagram of an exemplary overview of a multi-modality root cause localization system, in accordance with embodiments of the present invention;

FIG. 6 is an exemplary block/flow diagram of log messages and a log key sequence, in accordance with embodiments of the present invention;

FIG. 7 is a block/flow diagram of an exemplary overview of the multi-modality root cause localization system, in accordance with embodiments of the present invention;

FIG. 8 is a block/flow diagram of an exemplary processing system for detecting pod and node candidates from cloud computing systems representing potential root causes of failure or fault activities, in accordance with embodiments of the present invention; and

FIG. 9 is a block/flow diagram of an exemplary method for detecting pod and node candidates from cloud computing systems representing potential root causes of failure or fault activities, in accordance with embodiments of the present invention.

### DETAILED DESCRIPTION OF PREFERRED EMBODIMENTS

Multi-modality data including metrics data, log data, and configuration data can be collected from different sources and agents of cloud systems. Multi-modality data describe different aspects of a monitored system.

Traditional domain-based IT management solutions can't keep up with the heterogeneity and volume of data. Traditional domain-based IT management solutions can't intelligently sort the significant events out of the crush of surrounding data. Traditional domain-based IT management solutions can't correlate data across different but interdependent environments. And traditional domain-based IT management solutions can't provide the real-time insight and predictive analysis that IT operations teams need to respond to issues fast enough to meet user and customer service level expectations.

The challenges mainly come from the complex system and data, such as the hierarchical and evolving topology structures. Large-scale information systems usually include different levels of components that work together in a highly complex, coordinated, and evolving manner. One example is cloud computing facilities with microservice architectures, which usually include hundreds of different levels of components that vary from operating systems, application software, etc.

The challenges further come from the generation of terabytes of heterogeneous data per day including metrics data, log data, and event data that overwhelm Ops engineers. Each type/source of data offers some clues, but due to complexity and volume, each is difficult to manually analyze, let alone collectively analyze all data sources.

The exemplary embodiments address the issue of multi-modality root cause localization. More specifically, by collecting the monitored system performance data (such as latency, connection time, idle time, etc.) and a set of multi-modality data including metrics and logs of all the running containers/nodes and pods before and after the failure/fault events happen, the goal is to accurately and effectively detect the top-k pods and/or nodes that are most likely to be the candidates of the root cause of the failure/fault activities. This technology can be used to aid in failure/fault diagnosis in cloud/microservice systems, which is a core problem of AIOps (Artificial Intelligence for IT Operations).

The exemplary embodiments introduce a multi-modality root cause localization engine. Most existing root cause analysis techniques process time series and event logs separately, and thus cannot capture interplay between different data sources. Also, their time series monitoring cannot adjust the detection strategy based on system context revealed by events. Moreover, their event log analysis lacks the ability to identify the causes and implications in terms of system metrics and key performance indicators (KPIs).

The innovation of the exemplary embodiments relates to a monitoring agent designed to collect multi-modality data including performance KPI, metrics, and log data from the whole system and the underlying system components. A feature extraction or representation learning component is presented to convert the log data to time series data, so that the root cause analysis technique for time series, especially the causal discovery or inference methods, can be applied. To prioritize the metrics for root cause analysis and learn the importance of different metrics, the exemplary methods design a metric prioritization component based on the extreme value theory. To the integrated analysis of the multi-modality data, the exemplary methods employ a hierarchical graph neural network-based method to rank the root causes and learn the knowledge graph for further system diagnosis. The exemplary methods further utilize heterogeneous information to learn important inter-silo dynamics that existing methods cannot process.

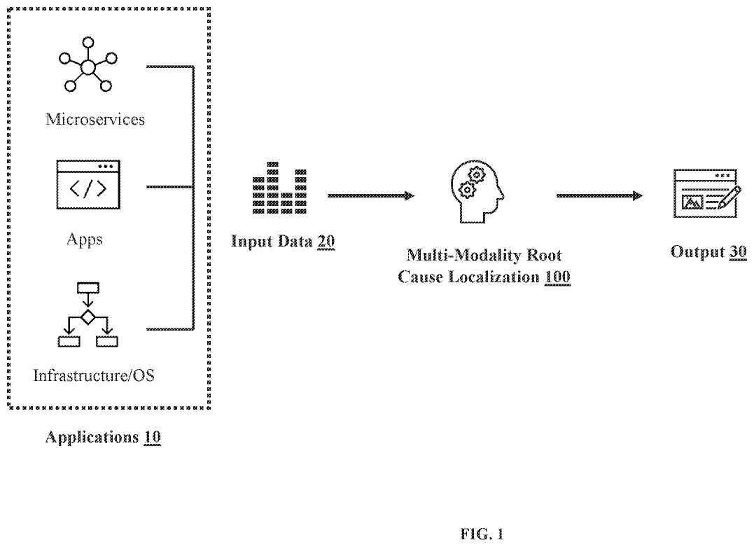

FIG. 1 is a block/flow diagram of an exemplary multi-modality root cause localization system applied to input data, in accordance with embodiments of the present invention.

Input data 20 is fed to the multi-modality root cause localization system 100 to obtain output 30. The input data 20 is extracted from applications 10.

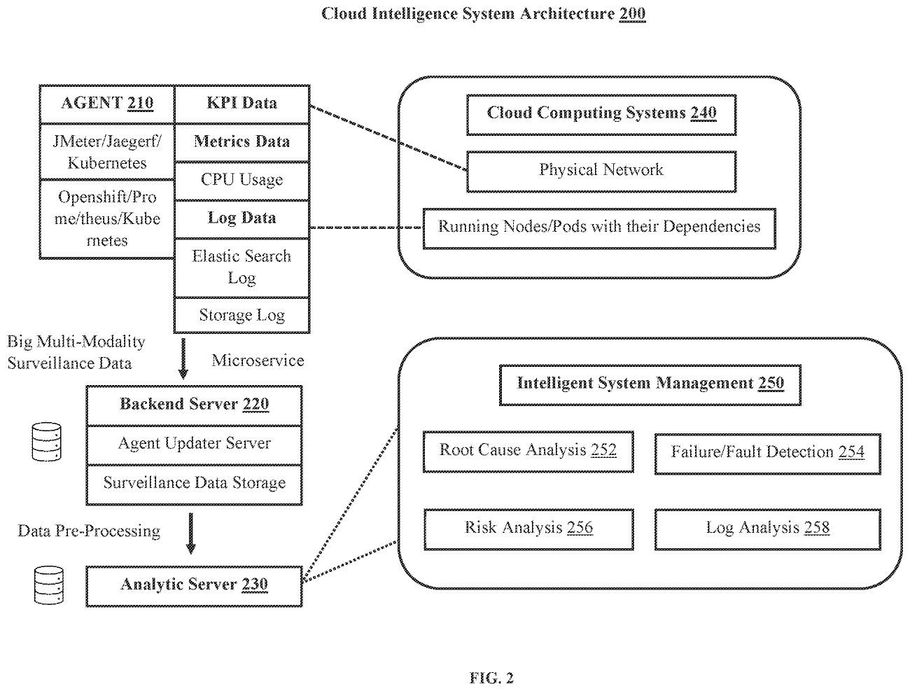

FIG. 2 shows the overall architecture 200 of the automated cloud intelligence system. One component is the agent 210, which installs JMeter/Jaeger in the cloud computing system 240 to periodically send requests from JMeter/Jaeger to the microservice and collects system-level performance KPI data. The agent 210 also installs Openshift/Prometheus to collect metrics and log data of all containers/nodes and applications/pods. The other component is the backend servers 220, which receive the data from the agents 210, pre-process the data, and send the processed data to the analytic or analysis server 230. The analytic server 230 runs the intelligent system management programs 250 to analyze the data. The root cause analysis engine 252 identifies the root causes of the system failure/faults by the failure/fault detector 254. The intelligent system management 250 further includes a risk analysis component 256 and a log analysis component 258. The technique of the exemplary embodiments is integrated in the root cause analysis engine 252.

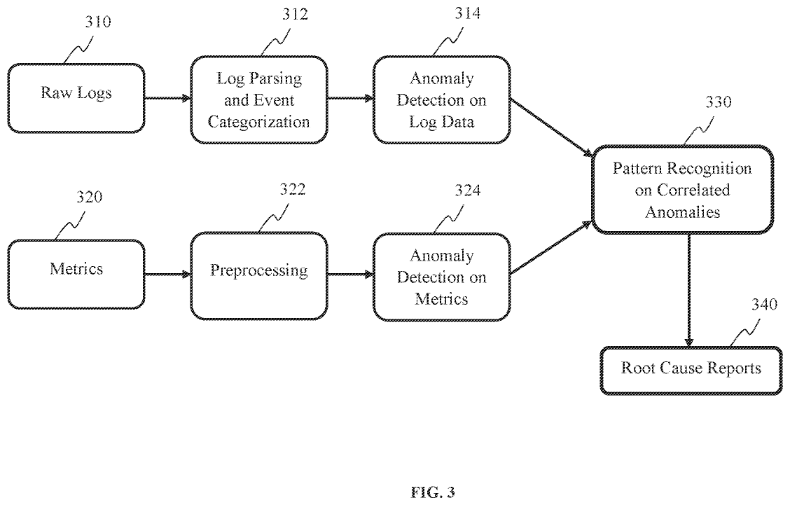

FIG. 3 is a block/flow diagram of existing multi-modal root cause localization.

The raw logs 310 are fed into the log parsing and event categorization component 312. Anomaly detection is performed on the log data via the anomaly detection component 314. The metrics 320 are pre-processed by the preprocessing component 322 and fed into the anomaly detection component 324 configured to detect anomalies on the metrics 320. The detected anomalies are fed into the pattern recognition component 330 and root cause reports 340 are generated.

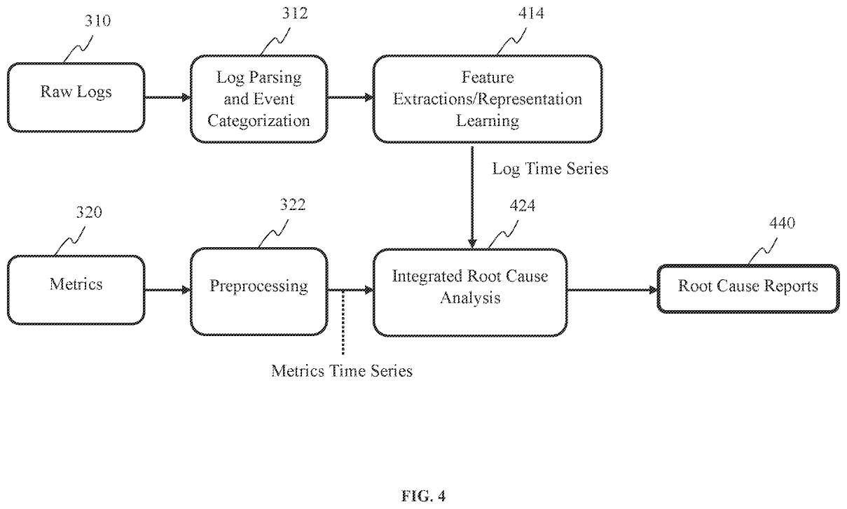

FIG. 4 is a block/flow diagram of an exemplary multi-modal root cause localization, in accordance with embodiments of the present invention.

The raw logs 310 are fed into the log parsing and event categorization component 312. The data is then provided to the feature extraction/representation learning component 414. The metrics 320 are pre-processed by the preprocessing component 322 and fed into the root cause analysis component 424 with the log time series data received from the feature extraction/representation learning component 414. Root cause reports 440 are then generated.

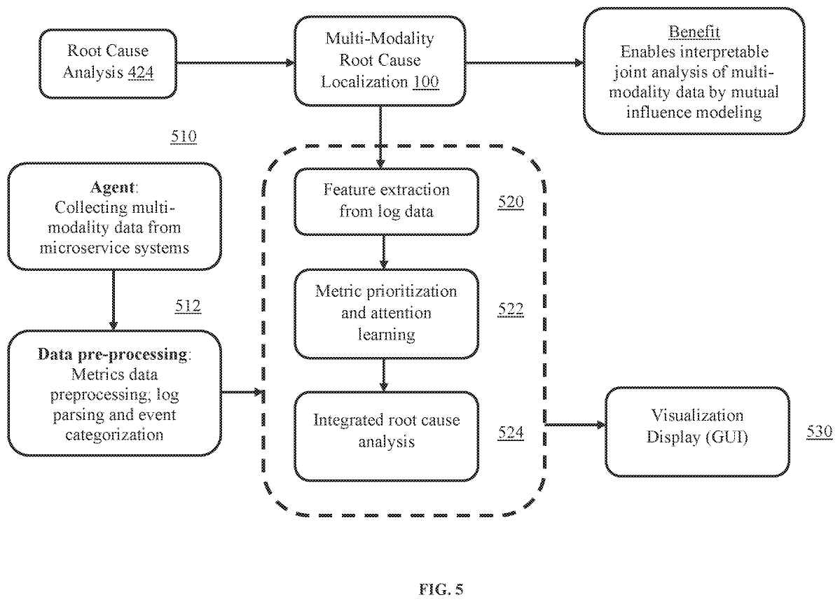

FIG. 5 is a block/flow diagram of an exemplary overview of a multi-modality root cause localization system, in accordance with embodiments of the present invention.

Regarding multi-modality data collection from the microservice system, the agent 510 collects the microservice data by employing the open-source JMeter and Openshift/Prometheus. Three types of monitored data are used in the root cause analysis engine, that is, the Key Performance Indicator (KPI) data of the whole system, the metrics data of the running containers/nodes and the applications/pods, and the log data of the containers and running pods.

The JMeter data includes the system performance KPI information such as elapsed time, latency, connect time, thread name, throughput, etc.

It is in the following format: timeStamp, elapsed, label, responseCode, responseMessage, threadName, dataType, success, failureMessage, bytes, sentBytes, grpThreads, allThreads, URL, Latency, IdleTime, Connect_time.

Jaeger, an open-source distributed tracing system, can also be used to monitor and analyze the performance of microservices. Jaeger collects a variety of KPI data from microservices.

Regarding latency, Jaeger measures the time taken for requests to travel through the cloud intelligence system architecture 200. This includes the time spent in each service as well as the time spent waiting for network transfers.

Regarding error rates, Jaeger tracks the number of errors that occur in the cloud intelligence system architecture 200, including 4xx and 5xx HTTP status codes, database errors, and other exceptions.

Regarding request volume, Jaeger measures the number of requests that the cloud intelligence system architecture 200 handles over a given period of time.

Regarding throughput, Jaeger measures the number of requests that the cloud intelligence system architecture 200 can handle in a given period of time, taking into account factors like network bandwidth, central processing unit (CPU) utilization, and more.

Regarding resource usage, Jaeger tracks the amount of CPU, memory, and other system resources used by the cloud intelligence system architecture 200, providing insights into performance bottlenecks and potential scalability issues.

The exemplary methods use the Latency/Connect_time as two key performance KPIs of the whole microservice system. The Latency measures the latency from just before sending the request to just after the first chunk of the response has been received, while Connect_time measures the time it took to establish the connection, including a secure sockets layer (SSL) handshake. Both Latency and Connect_time are time series data, which can indicate the system status and directly reflect the quality of service, that is, whether the whole system has some failure events that occurred or not, because the system failure would result in the latency or connect time significantly increasing.

The metrics data, on the other hand, includes a number of metrics which indicates the status of a microservice's underlying component/entity. The underlying component/entity can be a microservice's underlying physical machine/container/virtual machine/pod. The corresponding metrics can be the CPU utilization/saturation, memory utilization/saturation, or disk I/O utilization. All these metrics data are essentially time series data. An anomalous metric of a microservice's underlying component can be the potential root cause of an anomalous JMeter Latency/Connect_time, which indicates a microservice failure.

Collecting log data from a microservice system can be challenging as there are multiple services running independently, and each service generates its own log data.

Regarding centralized logging, centralized logging involves collecting log data from all the microservices into a single location. This can be achieved by using a logging framework such as ELK (Elasticsearch, Logstash, and Kibana). The microservices can be configured to send their logs to the logging framework via APIs or log agents.

Regarding container logging, since the microservices are running in containers, container logging tools such as Kubernetes Logging is used to collect log data. The logs are collected from containers and are stored in a central location.

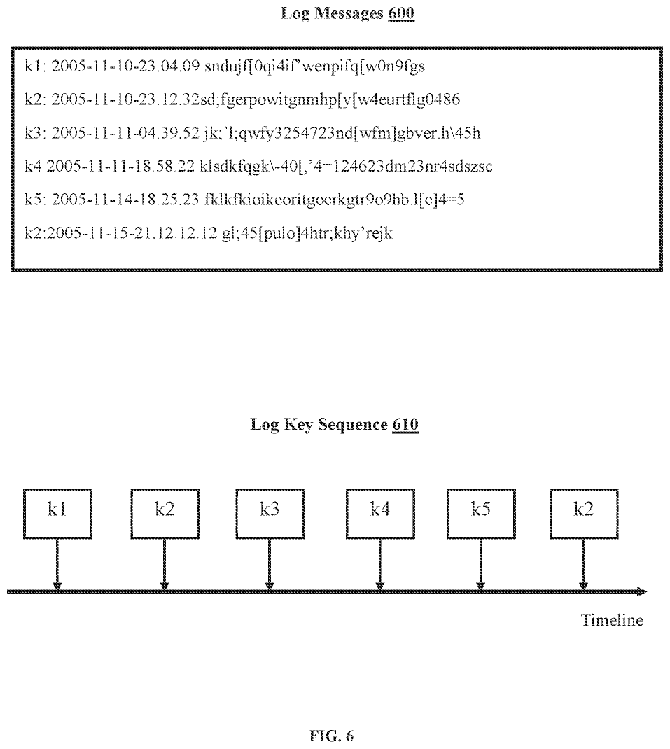

Regarding the data preprocessing component 512, for the log data, the exemplary methods first utilize an open-sourced log parser like “Drain” to learn the structure of the logs and parse them into event/value or key/value pairs as shown in FIG. 6, where the log messages 600 are parsed into the log key sequences 610. Based on the key/value pairs, the exemplary methods then categorize log messages into a “dictionary” of unique event types according to the involved system entities. For example, if two log messages include the entry of a same pod, they belong to the same category. And for each category, log keys are sliced using time sliding windows.

For metrics data, it is possible that there are different levels of data like high-level (e.g., node level) system metric data and low-level (e.g., pod-level) system metric data and for each level, there are different metrics (like CPU usage, memory usage, etc.). The data of the same level is extracted, and the same metric is used to construct the multivariate time series with columns representing system entities (like pods) and rows representing different timestamps.

Regarding the feature extraction/representation learning on log data 520 (feature extractor 520), to capture the interplay between metrics and log data, the exemplary methods employ feature extraction or representation learning techniques to convert log data into the same format (e.g., time series) as metrics data. A novel representation learning model with two sub-components for log data is presented. The first is an auto-encoder model and the second is a language model.

The auto-encoder includes an encoder network and a decoder network. The encoder network encodes a categorical sequence into a low-dimensional dense real-valued vector, from which the decoder aims to reconstruct the sequence. Due to its effectiveness for sequence modeling, long short-term memory (LSTM) is used as the base model for both the encoder and the decoder networks.

Specifically, given a normal sequence in the training set, e.g., Sⁱ=(x₁ⁱ, x₂ⁱ, . . . x_{N}_{ⁱ}ⁱ), the LSTM encoder is used to learn a representation of the whole sequence, step by step, as follows:

fₜ=σ_{g}(W_{f}xₜⁱ+U_{f}hₜ₋₁+b_{f}) (1)

iₜ=σ_{g}(Wᵢxₜⁱ+Uᵢhₜ₋₁+bᵢ)

oₜ=σ_{g}(Wₒxₜⁱ+Uₒhₜ₋₁+bₒ)

\tilde{c}ₜ=tan h(W_{c}xₜ+U_{c}hₜ₋₁+b_{c})

cₜ=fₜ⊙cₜ₋₁+iₜ+\tilde{c}ₜ

hₜ=oₜ⊙cₜ

Here xₜ is the input embedding of the t^{th} element in Sⁱ, fₜ, iₜ, oₜ are named as forget gate, input gate, output gate, respectively. In addition, W_{*}, U_{*}, and b_{*} (*∈{f, i, o, c}) are all trainable parameters of the LSTM. The exemplary methods use the final state h_{N}_{ⁱ} obtained by LSTM as the representation of the whole sequence as it summarizes all the information in the previous steps. With the sequence representation h_{N}_{ⁱ}, the LSTM decoder attempts to reconstruct the original sequence recursively as follows:

hₜⁱ=LSTM(hₜ₋₁, \tilde{x}ₜ₋₁ⁱ) (2)

pₜⁱ=Softmax(ReLU(W^{p}hₜⁱ+b^{p}))

êₜⁱ=OneHot(argmax(pₜⁱ))

\hat{x}ₜⁱ=E^{T}·êₜⁱ

Here LSTM is defined in Equation (1), and pₜⁱ∈ [symbol] ^{|∈|} is the probability distribution over all possible events. W^{p} and b^{p} are trainable parameters. argmax is the function to obtain the index of largest entry of pₜⁱ, Softmax normalizes the probability distribution, and ReLU is an activation function defined as:

ReLu(x)=max (0, x) (3)

Moreover, êₜⁱ is the predicted event at step t . In addition, the start hidden state and input event are h_{N}_{ⁱ} and special SOS event, respectively.

To optimize the parameters for the encoder and decoder, the negative log likelihood loss is used as the objective function, which is defined as follows:

$${L}_{AE} = {\sum }_{i = 1}^{N} {\sum }_{j = 1}^{{N}^{i}} - log ( {e}_{j}^{iT} {p}_{j}^{i} ) \qquad ( 4 )$$

When the encoder and decoder are trained to reach their optimum, that it, difference between the original and reconstructed sequences is minimum, the representation vector, e.g., h_{N}_{ⁱ} produced by the encoder includes as much information of the sequence as possible.

Regarding the language model, the language model is trained to predict the next event given the previous events in the sequences. Again, an LSTM model is used as the base of the language model. Correctly, given the previous events of at step t, the next event is predicted as:

hₜⁱ=LSTM((x₁ⁱ,x₂ⁱ, . . . , xₜⁱ)) (5)

pₜ₊₁ⁱ=Softmax(ReLU(W^{l}hₜⁱ+b^{l}))

êₜ₊₁ⁱ=OneHot(argmac(pₜ₊₁ⁱ))

Again, pₜ₊₁ⁱ is the probability distribution over all possible events and êₜ₊₁ⁱ is the one-hot representation of the predicted next event. Similarly, the negative log likelihood loss is used as the objective function. In this way, the trained language model is able to incorporate sequential dependencies in the sequences and measure the likelihood of any given sequence. This likelihood measurement and the vector produced by the encoder are concatenated together to form the final representation of a sequence, that is, v.

The feature extraction component 520 is quite flexible. Different feature extraction or representation learning techniques can be applied. An alternative way is to employ the Principle Component Analysis (PCA) based method. Specifically, the exemplary methods first construct a count matrix M, where each row represents a sequence, each column denotes a log key, and each entry M(i, j) indicates the count of jth log key in the ith sequence. Next, PCA learns a transformed coordinate system with the projection lengths of each sequence. The projection lengths form the time series of log data.

One example of the converted time series by extracting features from log data can be found below:

| | | Extracted |
|---|---|---|
| Time | Pod | Feature Value |
| 2021-12-02 23:00:07+00:00 | book-info_ratings-v2- | 0.1 |
| | 5bddd98984-wwnhx | |
| 2021-12-02 23:00:19+00:00 | book-info_ratings-v2- | 0.3 |
| | 5bddd98984-wwnhx | |
| 2021-12-02 23:00:31+00:00 | book-info_ratings-v2- | 0.5 |
| | 5bddd98984-wwnhx | |
| 2021-12-02 23:00:43+00:00 | book-info_ratings-v2- | 0.8 |
| | 5bddd98984-wwnhx | |

Regarding the metrics prioritization and attention learning component 522 (metric prioritizer and attention learner 522), after the feature extractor 520, the log data have been successfully converted into time series data, which is in the same format of metrics data. Now each extracted feature or representation of log can be considered as another metric in addition to CPU usage, memory usage, etc. Different metrics contribute to the failure event differently. For example, the CPU usage contributes more than the other metrics on the failure cases related to the high CPU load.

To prioritize the metrics for root cause analysis and learn the importance of different metrics, the exemplary methods adopt the extreme value theory-based method named SPOT. It is assumed that the root cause metrics should become anomalous in some time before failure time. The anomaly degree of metrics is evaluated based on SPOT.

The exemplary methods define the anomaly degree of the metric i as ∂ⁱ. Given a time series of metric Mⁱ=M₀ⁱ, M₁ⁱ, . . . , M_{T}ⁱ the index set of the anomaly point of Mⁱ is ε. The threshold in SPOT is denoted as Mₜⁱ is ω_{M}_{ₜ}_{ⁱ}. Then the ∂ⁱ is calculated as follows:

$${\partial }^{i} = {max}_{j ∈ ε} \frac{\vert {M}_{j}^{i} - {ω}_{{M}_{j}^{i}} \vert}{{ω}_{{M}_{j}^{i}}}$$

Since it is often that there are many time series of metric Mⁱ (e.g., 100 different pods with the CPU usage metric), the maximum one ∂ₘₐₓⁱ is chosen as the representative.

The metric with a larger ∂ₘₐₓⁱ has a higher priority. If there are too many metrics, to reduce the computational cost in the root cause analysis, the metrics with very low priorities can be discarded. The normalized ∂ₘₐₓⁱ will be used as the attention/weight for the metric in the integrated root cause analysis 524.

Regarding the integrated root cause analysis 524 (integrated root cause analyzer 524), for each metric data including the log as one metric, the exemplary methods apply the hierarchical graph neural network-based method to localize the root causes. When a system failure happens, it first conducts topological cause learning by extracting causal relations and propagating the system failure over the learned causal graph. Consequently, a topological cause score representing how much a component can be the root cause will be obtained. Second, it applies an individual cause learning via the extreme value theory to detect anomalous entities. By aggregating the results from topological cause learning and individual cause learning, a root cause ranking is obtained to discover most probable root causes, as well as a causal graph serving as a system knowledge graph for system insights.

After applying root cause localization for all the metrics, the exemplary methods assign the learned attention/weight to each metric and aggregate the results to generate the final root cause ranking, which is displayed by the visualization display 530.

Therefore, in conclusion, the proposed method is the first engine for interpretable joint root cause analysis of time series and events by mutual influence modeling. By ingesting heterogeneous data from different sources across all components of the IT environment, the exemplary methods break data silos and enhance monitoring and diagnose efficiency by understanding the interplay between system components.

In contrast to existing approaches, the exemplary embodiments combine latent states from both time series and log event streams to discover influence patterns between different log events and metrics and to capture uncertainty. The exemplary methods are more accurate (e.g., provide for higher quality) on root cause localization. Hence, the generated root causes will have less false positives and false negatives.

In contrast to traditional anomaly detection-based root cause analysis approaches for log data, the exemplary framework enables a user to extend the causal discovery/interference methods on time series to log data.

Traditional methods can only leverage the metrics directly collected by the monitoring agents, whereas the exemplary feature extraction/representation learning method enables a user to learn different features or representations from log data as additional metrics for root cause analysis.

In traditional root cause identification methods of microservice systems, prior knowledge is needed to select the correlated metrics to the root cause. In contrast, the exemplary methods automatically prioritize the metrics for root cause analysis to reduce the computational cost and learn the importance of each metric. Moreover, the proposed method can be applied in real-time root cause identification.

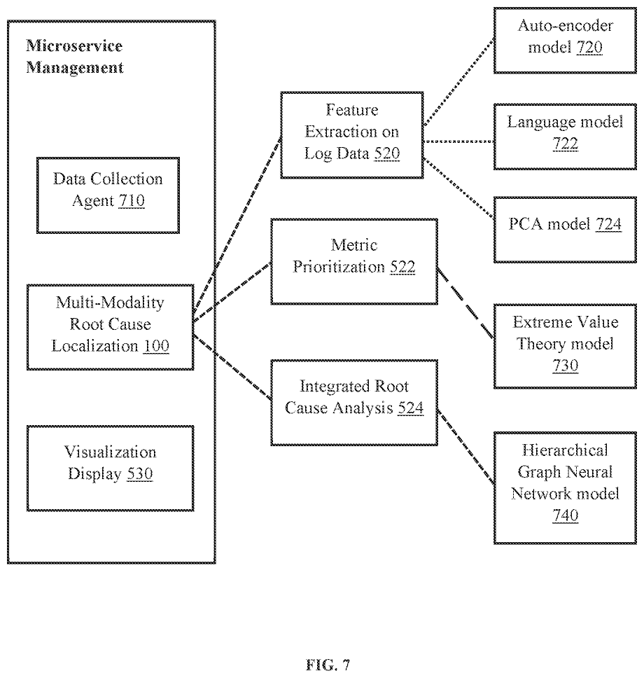

FIG. 7 is a block/flow diagram of an exemplary overview of the multi-modality root cause localization system, in accordance with embodiments of the present invention.

The microservice management system includes a data collection agent 710, the multi-modality root cause localization system 100, and the visualization display 530. The multi-modality root cause localization system 100 employs the feature extraction component 520, metric prioritization component 522, and the integrated root cause analysis component 524.

The feature extraction component 520 employs an autoencoder model 720, a language model 722, and a PCA model 724. The metric prioritization component 522 employs the extreme value theory model 730. The integrated root cause analysis component 524 employs the hierarchical graph neutral network model 740.

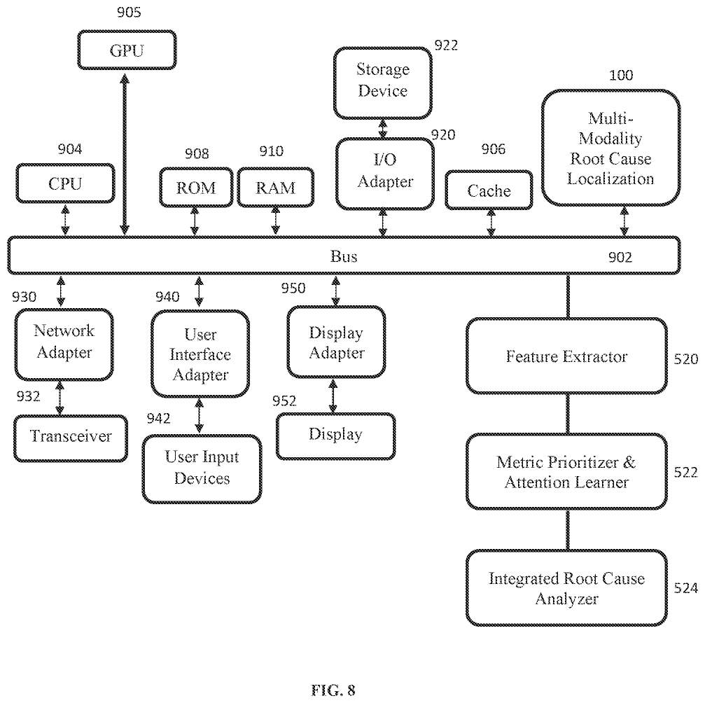

FIG. 8 is an exemplary processing system for detecting pod and node candidates from cloud computing systems representing potential root causes of failure or fault activities, in accordance with embodiments of the present invention.

The processing system includes at least one processor (CPU) 904 operatively coupled to other components via a system bus 902. A GPU 905, a cache 906, a Read Only Memory (ROM) 908, a Random Access Memory (RAM) 910, an input/output (I/O) adapter 920, a network adapter 930, a user interface adapter 940, and a display adapter 950, are operatively coupled to the system bus 902. Additionally, the multi-modality root cause localization system 100 employs the feature extraction component 520 (feature extractor), metric prioritization component 522 (metric prioritizer and attention learner), and the integrated root cause analysis component 524 (integrated root cause analyzer).

A storage device 922 is operatively coupled to system bus 902 by the I/O adapter 920. The storage device 922 can be any of a disk storage device (e.g., a magnetic or optical disk storage device), a solid-state magnetic device, and so forth.

A transceiver 932 is operatively coupled to system bus 902 by network adapter 930.

User input devices 942 are operatively coupled to system bus 902 by user interface adapter 940. The user input devices 942 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present invention. The user input devices 942 can be the same type of user input device or different types of user input devices. The user input devices 942 are used to input and output information to and from the processing system.

A display device 952 is operatively coupled to system bus 902 by display adapter 950.

Of course, the processing system may also include other elements (not shown), as readily contemplated by one of skill in the art, as well as omit certain elements. For example, various other input devices and/or output devices can be included in the system, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system are readily contemplated by one of ordinary skill in the art given the teachings of the present invention provided herein.

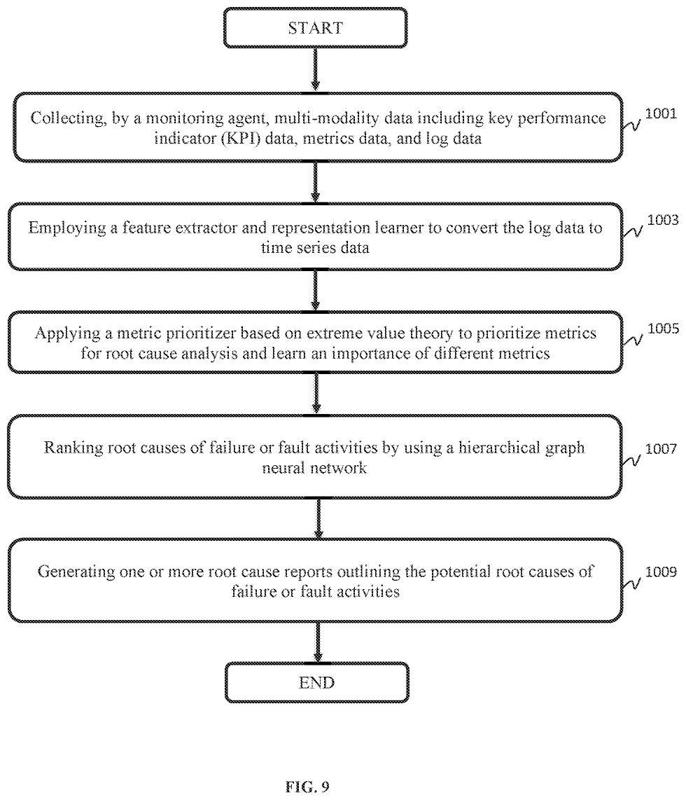

FIG. 9 is a block/flow diagram of an exemplary method for detecting pod and node candidates from cloud computing systems representing potential root causes of failure or fault activities, in accordance with embodiments of the present invention.

At block 1001, collect, by a monitoring agent, multi-modality data including key performance indicator (KPI) data, metrics data, and log data.

At block 1003, employ a feature extractor and representation learner to convert the log data to time series data.

At block 1005, apply a metric prioritizer based on extreme value theory to prioritize metrics for root cause analysis and learn an importance of different metrics.

At block 1007, rank root causes of failure or fault activities by using a hierarchical graph neural network.

At block 1009, generate one or more root cause reports outlining the potential root causes of failure or fault activities.

As used herein, the terms “data,” “content,” “information” and similar terms can be used interchangeably to refer to data capable of being captured, transmitted, received, displayed and/or stored in accordance with various example embodiments. Thus, use of any such terms should not be taken to limit the spirit and scope of the disclosure. Further, where a computing device is described herein to receive data from another computing device, the data can be received directly from the another computing device or can be received indirectly via one or more intermediary computing devices, such as, for example, one or more servers, relays, routers, network access points, base stations, and/or the like. Similarly, where a computing device is described herein to send data to another computing device, the data can be sent directly to the another computing device or can be sent indirectly via one or more intermediary computing devices, such as, for example, one or more servers, relays, routers, network access points, base stations, and/or the like.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” “calculator,” “device,” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical data storage device, a magnetic data storage device, or any suitable combination of the foregoing. In the context of this document, a computer readable storage medium may be any tangible medium that can include, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks or modules.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks or modules.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks or modules.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for detecting pod and node candidates from cloud computing systems representing potential root causes of failure or fault activities, the method comprising:
collecting, by a monitoring agent, multi-modality data including key performance indicator (KPI) data, metrics data, and log data;
employing a feature extractor and representation learner to convert the log data to time series data;
applying a metric prioritizer based on extreme value theory to prioritize metrics for root cause analysis and learn an importance of different metrics;
ranking root causes of failure or fault activities by using a hierarchical graph neural network; and
generating one or more root cause reports outlining the potential root causes of failure or fault activities.

2. The method of claim 1, wherein the feature extractor uses an auto-encoder model and a language model.

3. The method of claim 2, wherein the auto-encoder model includes an encoder network and a decoder network, the encoder network encoding a categorical sequence into a low-dimensional dense real-valued vector.

4. The method of claim 2, wherein the language model is trained to predict a next event given previous events in a categorical sequence.

5. The method of claim 1, wherein the feature extractor uses Principal Component Analysis (PCA) by constructing a count matrix and learning a transformed coordinate system with projection lengths of each categorical sequence.

6. The method of claim 1, wherein the hierarchical graph neural network conducts topological cause learning by extracting causal relations and propagating system failures over a learned causal graph to obtain a topological cause score.

7. The method of claim 1, wherein heterogeneous information is used to learn inter-silo dynamics.

8. A non-transitory computer-readable storage medium comprising a computer-readable program for detecting pod and node candidates from cloud computing systems representing potential root causes of failure or fault activities, wherein the computer-readable program when executed on a computer causes the computer to perform the steps of:
collecting, by a monitoring agent, multi-modality data including key performance indicator (KPI) data, metrics data, and log data;
employing a feature extractor and representation learner to convert the log data to time series data;
applying a metric prioritizer based on extreme value theory to prioritize metrics for root cause analysis and learn an importance of different metrics;
ranking root causes of failure or fault activities by using a hierarchical graph neural network; and
generating one or more root cause reports outlining the potential root causes of failure or fault activities.

9. The non-transitory computer-readable storage medium of claim 8, wherein the feature extractor uses an auto-encoder model and a language model.

10. The non-transitory computer-readable storage medium of claim 9, wherein the auto-encoder model includes an encoder network and a decoder network, the encoder network encoding a categorical sequence into a low-dimensional dense real-valued vector.

11. The non-transitory computer-readable storage medium of claim 9, wherein the language model is trained to predict a next event given previous events in a categorical sequence.

12. The non-transitory computer-readable storage medium of claim 8, wherein the feature extractor uses Principal Component Analysis (PCA) by constructing a count matrix and learning a transformed coordinate system with projection lengths of each categorical sequence.

13. The non-transitory computer-readable storage medium of claim 8, wherein the hierarchical graph neural network conducts topological cause learning by extracting causal relations and propagating system failures over a learned causal graph to obtain a topological cause score.

14. The non-transitory computer-readable storage medium of claim 8, wherein heterogeneous information is used to learn inter-silo dynamics.

15. A system for detecting pod and node candidates from cloud computing systems representing potential root causes of failure or fault activities, the system comprising:
a processor; and
a memory that stores a computer program, which, when executed by the processor, causes the processor to:
collect, by a monitoring agent, multi-modality data including key performance indicator (KPI) data, metrics data, and log data;
employ a feature extractor and representation learner to convert the log data to time series data;
apply a metric prioritizer based on extreme value theory to prioritize metrics for root cause analysis and learn an importance of different metrics;
rank root causes of failure or fault activities by using a hierarchical graph neural network; and
generate one or more root cause reports outlining the potential root causes of failure or fault activities.

16. The system of claim 15, wherein the feature extractor uses an auto-encoder model and a language model.

17. The system of claim 16, wherein the auto-encoder model includes an encoder network and a decoder network, the encoder network encoding a categorical sequence into a low-dimensional dense real-valued vector.

18. The system of claim 16, wherein the language model is trained to predict a next event given previous events in a categorical sequence.

19. The system of claim 15, wherein the feature extractor uses Principal Component Analysis (PCA) by constructing a count matrix and learning a transformed coordinate system with projection lengths of each categorical sequence.

20. The system of claim 15, wherein the hierarchical graph neural network conducts topological cause learning by extracting causal relations and propagating system failures over a learned causal graph to obtain a topological cause score.
